(19) United States
(12) Patent Application Publication
(10) Pub. No.: US 2024/0202275 A1
(43) Pub. Date: Jun. 20, 2024

(54) ASSIGNING DNN WEIGHTS TO A 3D CROSSBAR ARRAY

(71) Applicant: International Business Machines Corporation, Armonk, NY (US)

(72) Inventors: Geoffrey Burr, Cupertino, CA (US); HsinYu Tsai, Cupertino, CA (US); Irem Boybat Kara, Adliswil (CH); Martin Michael Frank, Dobbs Ferry, NY (US)

(21) Appl. No.: 18/085,011

(22) Filed: Dec. 20, 2022

(51) Int. Cl. G06F 12/02; G06F 17/16

(52) U.S. Cl. CPC G06F 12/0207; G06F 17/16

(57) ABSTRACT

A system, method and computer program product for assigning deep neural network (DNN) weight matrices to a Compute-in-Memory (CiM) accelerator system, and particularly, efficient allocation strategies for assigning DNN model weight-layers to two-dimensional (2D) tiers of three-dimensional (3D) crossbar array tiles. Such efficient allocation strategies for assigning DNN model weight-layers to tiers and tiles of a CiM accelerator are optimized to minimize contention, latency and dead-time, and to maximize accelerator throughput. In one scenario, efficient allocation strategies include assigning DNN weight matrices to the 2D tiers of a 3D crossbar array tile to maximize throughput and minimize completion latency for a finite-batch-size example of an incoming workflow. In a further scenario, efficient allocation strategies assign DNN weight matrices to the 2D tiers of a 3D crossbar array tile to minimize dead-time-latency-before-next-batch-member-can-be-input in an infinite-batch-size or a continuous workflow scenario.

### FIELD

The present disclosure relates to deep learning machine learning models and more particularly, to a Deep Neural Network (DNN) model system accelerator configuration of plural 3-dimensional crossbar array tiles that each includes plural 2-dimensional tiers of compute-in-memory structures and methods to assign DNN model weight matrices to the tiers and tiles.

### BACKGROUND

An analog AI in-memory computing chip typically consists of multiple arrays of memory devices that communicate with each other. Many types of volatile memory such as static random-access memory (SRAM) and dynamic random-access memory (DRAM) as well as non-volatile memory such as phase-change memory (PCM), resistive random-access memory (RRAM), magnetic random-access memory (MRAM), ferroelectric field-effect transistor (FeFET), and Flash memory can be used for in-memory computing.

Many memory devices have the ability to store weights in their conductance state. When these devices are arranged in a crossbar configuration, it allows to perform a matrix-vector multiplication in a single time step, exploiting the advantages of storage capability and Kirchhoff's circuits laws.

In deep neural network (DNN) learning applications that use multi-layered machine learning model architectures, data propagation through multiple layers of the neural network model involves, among other operations, a sequence of matrix multiplications, as certain types of layers, such as fully connected layers, can be represented as a matrix of weights. The devices are arranged in multiple crossbar arrays, creating an artificial neural network where all matrix multiplications are performed in-place in an analog manner. This structure allows to run deep learning models at reduced energy consumption.

In a “weight-stationary” dataflow architecture such as implemented in Analog-AI chips, computations are performed at the location of weights. However, this leads to one of the conventional weaknesses of such a weight-stationary architecture: since each weight must have its “own” memory location, one runs the risk of rapidly running out of “enough” memory to handle a very large model or to handle a large number of different models of modest size.

Multi-tier memory in Analog AI chips, in which crossbar computations are performed by selecting one “tier” (a 2D slice) out of a 3D memory “tile,” offers an attractive solution to this problem. The types of multi-tier/3D memory that can be adapted for such use include, but are not limited to: 3D NAND Flash memory, other types of 3D floating gate or charge trap memory, 3D PCM, 3D RRAM, 3D MRAM, and 3D FeFET memory.

However, while the prospect of assigning more than one of the weight-matrices in a given model to the same 3D memory “tile,” so that a given tile may participate in each workload batch to implement Layer N within the network, e.g., using tier n, and then that same tile may participate in a different portion of the same workload to implement Layer M, e.g., using tier m, is particularly attractive for very large models, the assignment of which layers of the network should be assigned to the same tiles is a non-trivial one— any given tile can be used either to service Layer N using tier n, OR to service Layer M using tier m, but NOT both at the same time.

A poor assignment of layers to tiers can result in significant contention, either when a batch of some limited size (“finite batch”, e.g., 8 examples) is run through the weight-stationary system, or when a large batch or a continuous stream of inputs (“infinite batch”) is injected into the system.

Such contention issues can lead to longer execution time (worse “throughput”), slower latency to first output result in a finite-batch scenario, and longer “dead-time” latency before the next input can enter in the infinite-batch scenario.

### SUMMARY

A system, method and computer program product for efficient allocation strategies for assigning DNN weight matrices to the 2D tiers of a 3D crossbar array tile to minimize contention, such as by maximizing throughput and minimizing completion latency for a finite-batch-size scenario.

A system, method and computer program product for efficient allocation strategies for assigning DNN weight matrices to the 2D tiers of a 3D crossbar array tile to minimize dead-time-latency-before-next-batch-member-can-be-input in an infinite-batch size scenario or continuous workflow scenario.

In one aspect, there is provided a compute-in-memory (CiM) accelerator system. The CiM accelerator system comprises: a plurality of in-memory tiles, each in-memory tile comprising more than one tier arranged in the Z dimension, each tier of an in-memory tile including an array of memory devices for storing a 2D weight-matrix of data representing at least a portion of a neural network model layer, wherein at least one in-memory tile is configured to perform vector-matrix multiplications (VMM) from successive neural network layers mapped into more than one tier, and no in-memory tile is configured to represent vector-matrix multiplications of non-successive neural network layers.

According to this aspect, N neural network model layers are assigned to tiers of in-memory tiles, the assignment of N neural network model layers to tiers of in-memory tiles being optimized for a finite example batch-size m.

Further, in accordance with this aspect, of the N neural network model layers, an amount Dᵢ of successive neural network model layers are assigned to a given in-memory tile i at tiers of that tile i, a usage of successive Dᵢ neural network model layers at the given in-memory tile i being collapsed into one continuous time-period.

Further, the amount Dᵢ of assigned successive neural network model layers is determined by minimizing max(tᵢ), where tᵢ comprises a latency of an in-memory tile i, the latency tᵢ computed according to: tᵢ>=Σtᵢⱼ, where tᵢⱼ denotes the latency of utilized tier j within that tile, and where max(tᵢ) denotes the highest such tᵢ found among all in-memory tiles i storing a 2D weight-matrix representing at least a portion of the N neural network model layers.

In an embodiment, each in-memory tile processes a batch-member until vector matrix multiplication computations are completed on all Dᵢ layers assigned to that in-memory tile i.

In a further aspect, there is provided a compute-in-memory accelerator system. The CiM accelerator system comprises: a plurality of in-memory tiles, each in-memory tile comprising more than one tier arranged in the Z dimension, each tier including an array of memory devices for storing a 2D weight-matrix of data representing a neural network model layer, wherein a mapping of a sequence of at least Nₜᵢₑᵣ₁ neural network model layers to tiers of successive in-memory tiles is optimized for a finite example batch-size m of an incoming workflow, the mapping comprising an assignment of layers Nₛₜₐᵣₜ to Nₛₜₐᵣₜ+Nₜᵢₑᵣ₁−1 of the neural network model to a first tier (tier 1) of successive in-memory tiles 1 to Nₜᵢₗₑₛ, each first tier of the successive in-memory tiles 1 to Nₜᵢₗₑₛ configured for storing data representing a 2D weight-matrix for processing at the corresponding neural network model layer; and an assignment of layer Nₛₜₐᵣₜ+Nₜᵢₑᵣ₁ of the neural network model to a second tier (tier 2) of in-memory tile 1, the second tier of in-memory tile 1 configured for storing data representing a 2D weight-matrix for processing at the corresponding neural network model layer, wherein the Nₜᵢₗₑₛ is a minimum number of tiles chosen such that the first batch member completes processing in tier 1 of tile Nₜᵢₗₑₛ no sooner than the math batch member completes processing in tier 1 of in-memory tile 1; and a controller unit associated with each in-memory tile configured for controlling a 2D weight-matrix multiplication operation of at least a portion of a neural network model layer at a tier of the in-memory tile.

According to this aspect, subsequent successive neural network model layers greater than the Nth layer are mapped to a second tier (tier 2) of each in-memory tiles 1 to N in a 1:1 correspondence, and to avoid contention, N is determined as a minimum number of tiles as a function of a time when an m^{th} or last batch member completes processing in tier 1 of tile 1 and no later than the first batch member commences processing in tier 2 of tile 1.

Further, according to this aspect, the mapping further comprises: an assignment of any successive layers from neural network model layer Nₛₜₐᵣₜ+Nₜᵢₑᵣ₁+1 up to Nₛₜₐᵣₜ+2Nₜᵢₑᵣ₁−1 to tier 2 of in-memory tiles 2 to Nₜᵢₗₑₛ, and an assignment of any subsequent successive neural network model layers Nₛₜₐᵣₜ+(x-1)Nₜᵢₑᵣ₁ up to Nₛₜₐᵣₜ+XNₜᵢₑᵣ₁−1 to a next tier (tier x) of tiles 1 to Nₜᵢₗₑₛ for each x in a sequence of at least one successive whole numbers x≥ 3

In yet a further embodiment, there is provided a method for operating a compute-in-memory accelerator system. The method comprises: configuring a plurality of in-memory tiles to store data for processing a neural network model, each in-memory tile comprising more than one tier arranged in the Z dimension, each tier comprising an array of memory devices adapted to store a 2D weight-matrix of data representing a neural network model layer; mapping of a sequence of greater than N neural network model layers to tiers of successive in-memory tiles optimized for a finite sample batch-size m of an incoming workflow, the mapping comprising at least an assignment of layers Nₛₜₐᵣₜ to Nₛₜₐᵣₜ+Nₜᵢₑᵣ₁−1 of the neural network model to a first tier (tier 1) of successive in-memory tiles 1 to Nₜᵢₗₑₛ, each first tier of the successive in-memory tiles 1 to Nₜᵢₗₑₛ configured for storing data representing a 2D weight-matrix for processing at the corresponding neural network model layer; and an assignment of layer Nₛₜₐᵣₜ+Nₜᵢₑᵣ₁ of the neural network model to a second tier (tier 2) of in-memory tile 1, the second tier of in-memory tile 1 configured for storing data representing a 2D weight-matrix for processing at the corresponding neural network model layer; wherein the Nₜᵢₗₑₛ is a minimum number of tiles chosen such that the first batch member completes processing in tier 1 of tile Nₜᵢₗₑₛ no sooner than the math batch member completes processing in tier 1 of in-memory tile 1; and controlling a processing of a 2D weight-matrix multiplication operation of at least a portion of a the N neural network model layer at a tier of an in-memory tile.

According to this method, the mapping further comprises: an assignment of any successive layers from neural network model layer Nₛₜₐᵣₜ+Nₜᵢₑᵣ₁+1 up to Nₛₜₐᵣₜ+2Nₜᵢₑᵣ₁−1 to tier 2 of in-memory tiles 2 to Nₜᵢₗₑₛ and an assignment of any subsequent successive neural network model layers Nₛₜₐᵣₜ+(x-1) Nₜᵢₑᵣ₁ up to Nₛₜₐᵣₜ+XNₜᵢₑᵣ₁−1 to a next tier (tier x) of tiles 1 to Nₜᵢₗₑₛ for each x in a sequence of at least one successive whole numbers x≥ 3.

In a further aspect, there is provided a compute-in-memory (CiM) accelerator system. The CiM accelerator system comprises: a plurality of in-memory tiles, each in-memory tile comprising more than one tier arranged in the Z dimension, each tier including an array of memory devices for storing a 2D weight-matrix of data representing a neural network model layer; a mapping of a sequence of greater than N neural network model layers to tiers of successive in-memory tiles optimized for a large sample batch-size m of an incoming workflow, the mapping comprising at least an assignment of a pre-determined amount of successive neural network model layers to respective successive tiers of a single in-memory tile, each successive tier of the single in-memory tile configured for storing data representing a 2D weight-matrix for processing at the corresponding neural network model layer; and a hardware controller device configured for controlling a 2D weight-matrix multiplication operation at each successive neural network model layer at each successive tier of the given in-memory tile.

Further, in accordance with this aspect, of the N neural network model layers, an amount Dᵢ of successive neural network model layers are assigned to a given in-memory tile i at tiers of that tile i, a usage of successive Dᵢ neural network model layers at the given in-memory tile i being collapsed into one continuous time-period.

Further, the amount Dᵢ of assigned successive neural network model layers is determined by minimizing max(tᵢ), where tᵢ comprises a latency of an in-memory tile i, the latency tᵢ computed according to: tᵢ>=Σtᵢⱼ, where tᵢⱼ denotes the latency of utilized tier j within that tile, and where max(tᵢ) denotes the highest such tᵢ found among all in-memory tiles i storing a 2D weight-matrix representing at least a portion of the N neural network model layers.

Further, according to this aspect, a first tile becomes available to start processing of a next batch-member in the incoming workflow when processing of all Dᵢ layers assigned to that first in-memory tile i is completed.

In yet another aspect, there is provided a method for operating a compute-in-memory accelerator system, the method comprises: configuring a plurality of in-memory tiles to store data for processing a neural network model, each in-memory tile comprising more than one tier arranged in the Z dimension, each tier comprising an array of memory devices adapted to store a 2D weight-matrix of data representing a neural network model layer; mapping of a sequence of greater than N neural network model layers to tiers of successive in-memory tiles optimized for a large sample batch-size m of an incoming workflow, the mapping comprising assigning a pre-determined amount of successive neural network model layers to respective successive tiers of a single in-memory tile, each successive tier of the single in-memory tile configured for storing data representing a 2D weight-matrix for processing at the corresponding neural network model layer; and controlling a 2D weight-matrix multiplication operation at each the successive neural network model layers at each the successive tier of the given in-memory tile.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram of an example Compute-in-Memory (CiM) hardware and memory system accelerator to which DNN weight matrices are assigned in accordance with an embodiment of the invention;

FIG. 2 depicts graphically a conventional arrangement of neural network (NN) model layers that are to be computed in successive order as part of an AI machine learning algorithm;

FIG. 3 depicts graphically a mapping arrangement of neural network (NN) model layers that need to be computed in successive order as part of an AI machine learning algorithm and the employing of a weight assignment strategy for optimizing total throughput and latency for a finite batch-size of inputs according to an embodiment;

FIG. 4 depicts a method that can be programmed at a supervisory controller for mapping of NN model layers to in-memory tiles/tiers as depicted in FIG. 3 for a first case scenario where there is a finite batch size m of inputs according to an embodiment;

FIG. 5 depicts a model layers lockstep processing scenario according to the embodiment of FIG. 4 where batch members proceed a tier of one tile to the same tier of the next tile next in lockstep for a finite sized batch such as depicted by successive arrows from one tile to its next adjacent tile in an embodiment;

FIG. 6 depicts graphically a first mapping arrangement of neural network (NN) model layers that need to be computed in successive order as part of an AI machine learning algorithm and the employing of a weight assignment strategy for optimizing total throughput and latency for an “infinite” batch-size of inputs according to a first embodiment;

FIG. 7 depicts graphically a second mapping arrangement of neural network (NN) model layers that need to be computed in successive order as part of an AI machine learning algorithm and the employing of a weight assignment strategy for optimizing total throughput and latency for an “infinite” batch-size of inputs according to a second embodiment;

FIG. 8 depicts a method that can be programmed at a supervisory controller for determining D used for the programming of a mapping of NN model layers to circuit tiles/tiers when there is an infinite batch size m of inputs to be processed;

FIG. 9 depicts a method of an overall process flow for configuring a 3D CiM system according to embodiments described herein;

FIG. 10 depicts operations and the lockstep signal/data flow involving example 3D compute-in-memory (CiM) hardware at a tier(s) of a circuit tile of a memory system accelerator in accordance with an embodiment of the invention

FIG. 11 illustrates an example computing system for controlling the allocation of DNN weight matrices to the 2D tiers of a 3D crossbar array tile to minimize contention, latency and dead-time, and to maximize accelerator throughput according to an embodiment.

### DETAILED DESCRIPTION

In the case of deep-learning-based AI systems, the computation speed and throughput needs to be increased significantly. In-memory computing is one way that can be used for accelerating deep learning inference and training.

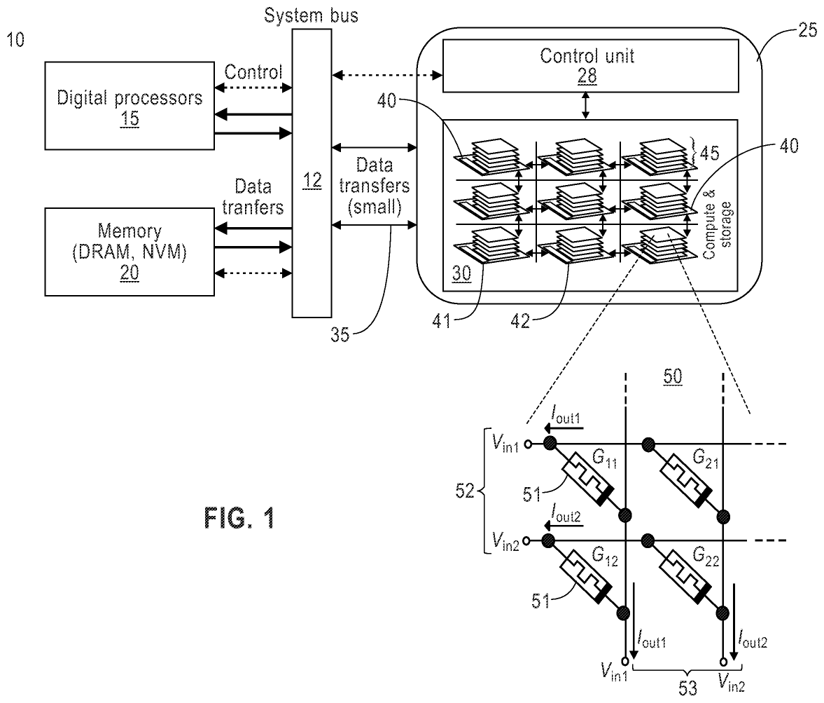

FIG. 1 illustrates a compute-in-memory accelerator system 10 that enables efficient allocation strategies for assigning DNN weight matrices to the 2D tiers of a 3D crossbar array tile to minimize contention, latency and dead-time, and to maximize accelerator throughput.

As shown in FIG. 1, a CiM accelerator system 10 includes one or more digital processors 15 that issue control signals for controlling operations for many applications involving data stored at a non-volatile memory (NVM) subsystem 20 including memory devices. A system communications bus 12 is provided for shuttling data back and forth between the memory 20 and the computational unit 15 when performing operations, e.g., neural network computations. In accordance with an aspect of the present disclosure, further connected to system communications bus 12 is a CiM device system 25 having a control unit such as a microprocessor 28 and multiple CiM tiles 40, with each tile 40 comprising a 3D compute in memory block comprising multiple tiers 45 of 3D CiM memory devices and also including associated computing circuitry used for controlling neural network computations, e.g., an in-place matrix-vector multiply (MVM) operation, at a tier. The microprocessor 28 can be configured to govern a computation path for performing CiM neural network operations, e.g., input/output and/or computations, involving a tier(s) at a tile(s). In an embodiment, depending upon a configuration of models, output data such as intermediate activations generated as a result of MVM operations performed at a tier of a tile, e.g., a tile 41, can be controlled for input/transfer to another CiM device, e.g., a tier at a same tile or at a different tile, e.g., tile 42, via a data transfer 50 using system data bus 12. In an embodiment, layer activations are inputs for different layers of the neural network model and is typically a vector of floating point/integer elements.

As shown in FIG. 1, each 3D CiM device tier at a tile 40 includes a resistive memory array, e.g., a two-dimensional array 50 of memristive devices in a cross-bar configuration adapted to perform a computational primitive such as an in-place matrix-vector multiply (MVM) operation with 0(1) time complexity by exploiting analog storage capability and Kirchhoff's circuits laws. As an example, at two-dimensional array 50 of memristive devices, the MVM operation can compute an MVM operation

$$[ \begin{matrix}{A}_{11} & {A}_{12} \\ {A}_{21} & {A}_{22}\end{matrix} ] [ \begin{matrix}{x}_{1} \\ {x}_{2}\end{matrix} ] = [ \begin{matrix}{b}_{1} \\ {b}_{2}\end{matrix} ]$$

where x₁ and x₂ are values of an input data vector and can map to Vin voltage values 52, A₁₁-A₂₂ values correspond to conductance (inverse resistance) values or “weights” stored at respective memristive devices 51 at the cross-bar array 50 at the tier, and b₁ and b₂ are output values converted from sensed output currents 53 read out of the array 50 at the tier. In the cross-bar configuration, a weight can be represented as a unit cell comprising more than one memristive device, and other devices such as an access transistor (not shown). Because all of the weights reside in the 3D memory architecture, and computations are performed in-memory, the bottleneck of shuttling weight data back and forth between the memory and the computational unit is completely eliminated.

Each 3D CiM device at a tile 40 offers significant weight storage capacity to store, for example, millions of parameters per CiM tile at high density, enabling efficient and fast inference (and potentially training) of, for example, billion-parameter sized models on a multi-tile CiM accelerator.

In an embodiment, the disclosure proposes to implement efficient allocation strategies for assigning DNN weight matrices to the 2D tiers of a 3D crossbar array tile to minimize contention, latency and dead-time, and to maximize accelerator throughput.

The advantage of this approach is that by being judicious as to which weight matrices share the same 3D crossbar array tile, latency and dead-time can be significantly reduced.

As used herein, the term “logical tier” refers to a scenario where multiple physical tiers are accessed simultaneously to implement one 2-D matrix of weights, i.e., a single weight is then represented by more than one device (tier) along the z axis. Thus, to perform the analog multiplication, the input voltage will be applied to all those devices simultaneously and the current from all those devices will be collected together and thus summed. This can achieve an averaging effect (reducing statistical errors.) A ‘tier’ thus can represent a ‘physical’ tier (i.e., one physical ‘sheet’ of devices/cells) or to a ‘logical’ tier (i.e., one or more physical ‘sheets’ of devices or cells, such that one or more devices along a ‘z string’ play the role of a single neural network weight.

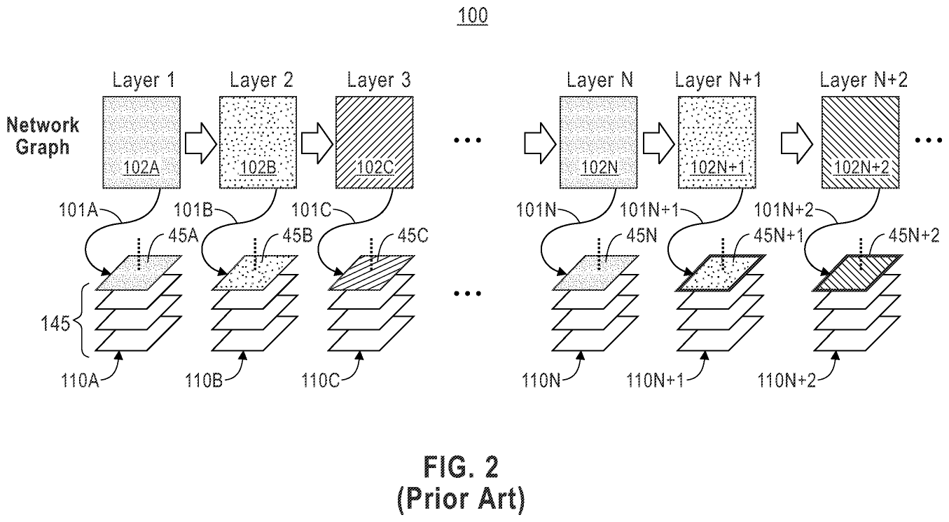

FIG. 2 depicts graphically an abstract arrangement 100 of a neural network (NN) model including model layers 102A, 102B, . . . , 102N, 102N+1 that need to be computed in successive order as part of an AI machine learning algorithm. A further layer graphically depicted includes layer 102N+2, etc. Here the word “Layer” describes a unique fully-connected or convolutional layer within the network requiring a unique weight-matrix. Further the word “successive” refers to a property that is determined by taking into account only “CiM-mappable” neural network layers, i.e., intervening layers that are executed in digital are ignored. In other words, two analog-mapped layers are considered “successive” if and only if there is no other analog-mapped layer between them.

As shown in FIG. 2, a 3-D CiM memory system 100 is organized as a plurality of circuit tiles 110A, 110B, 110C, . . . , 110N, 110N+1, etc. Each circuit tile 110A, 110B, etc. includes a plurality of tiers 145, each tier configured with CiM processing capability. In a non-limiting flow embodiment, a weight-stationary flow shows a programmed mapping 101A, 101B, . . . , 101N, 101N+1, 101N+2 of each respective NN model layer 102A, 102B, . . . , 102N, 102N+1, 102N+2 to a respective first tier, e.g., respective tier 45A, 45B, . . . , 45N, 45N+1, 45N+2 in a 1:1 correspondence with a respective corresponding circuit tile 110A, 110B, . . . , 110N, 110N+1, 110N+2. The conventional mapping scheme shown in FIG. 2 is a straightforward “fully weight stationary” organization of layers to tiles. Such an assignment effectively ignores the multi-tier capabilities of each tile, area-efficiency is worst-case, but both throughput and latency are fully optimized because the amount of contention for each tile is identical to single-tier analog-AI.

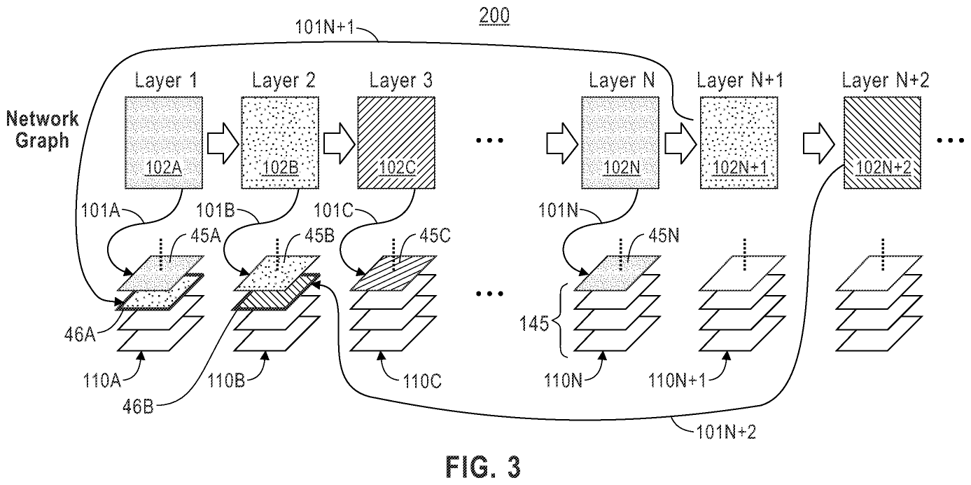

In a first embodiment, there is depicted in FIG. 3 a configuration and neural network (NN) model layers mapping scenario where it is desired to optimize total throughput and latency for a finite batch-size (e.g., a non-limiting batch size of 8 examples, 16 examples, or more) with the objective to avoid contention at each tile between different batch members.

As referred to herein, a batch size “m” represents the number of training examples in one forward/backward pass or running/training a DNN model or alternatively, the number of training instances shown to the DNN model before a weight update is performed. The higher the batch size, the more memory space is needed. For example, in the case of image classification, a single input 2-dimensional image (e.g., batch size one) can be subjected to a series of matrix multiplications and an output vector is output that contains information of what the image is. However, multiple images can be brought in at the same time, e.g., batch size=8, which could be a stack of eight images (a 3-D matrix or tensor), which matrix multiplications of the tensor would produce eight image classifications (e.g., eight 2-D matrices for pipelined processing).

FIG. 3 graphically depicts the abstract arrangement 200 of neural network (NN) model layers 102A, 102B, . . . , 102N, 102N+1 and 102N+2 as in FIG. 2 that need to be computed in successive order as part of an AI machine learning algorithm. Also depicted is the forming of a 3-D CiM memory system 200 organized as a plurality of circuit tiles 110A, 110B, 110C, . . . , 110N-1, 110N. Each tile 110A, 110B, etc. includes a plurality of tiers 145, each tier configured with CiM processing capability. In this embodiment for optimizing total throughput and latency for a finite batch-size, a programmed processor provides a respective mapping 101A, 101B, . 101N of each respective NN model layer 102A, 102B, . . . , 102N to a respective first tier, e.g., respective tier 45A, 45B, . . . , 45N with a respective corresponding tile 110A, 110B, . . . 110N in a 1:1 correspondence.

As shown in FIG. 3, the assignment of weights to tiers of circuit tiles 110A, 110B, et seq., has been optimized for a particular batch-size m. This is parameterized by “N” which is the number of layers to be assigned out to unique tiles before returning back to the original 1^{st} tile (e.g., first tile 110A) to place the weight-matrix for the N+1^{th} layer onto another tier (e.g., tier 46B) within that original 1^{st} tile (e.g., tile 110A). This subsequent mapping of NN model layer 102N+1 back to the first original circuit tile 110A at the second tier 46A is depicted as mapping 101N+1. As part of the next tier usage for remaining layers of the batch, e.g., layer N+2, the programmed mapping will include a mapping 101N+2 of NN model layer 102N+2 to the second processing tier 46B of second circuit tile 110B.

The size of N depends both on m and on the aggregate execution time of the workload through the various tiles in addition to any intermediate digital computation that must take place between tiles. As shown in the example scenario of FIG. 3, the size of N should be made large enough that the last (or m^{th}) member of the mini-batch should have exited the 1^{st} tile 110A (using the 1^{st} assigned tier 45A) before the first member of the mini-batch is ready to enter the 1^{st} tile 110A (using the 2^{nd} assigned tier 46A). This requires enough tiles to handle this portion of the workload (e.g., the first N layers) while assigning only one tier per tile. It is noted that it does not matter which tier is assigned so long as there is only 1 is assigned per tile, across these first N layers.

The case where the network contains local recursion which repeatedly sends data back to the same tile is handled by considering all the recursive accesses (e.g., across the tokens in a sentence or other sequence) as simply one contiguous usage of the tier and tile, as needed in order to perform the requisite computation for that particular network layer.

Assignment of the 2^{nd} tier to tiles should be made similarly, accounting for any differences in execution time across different layers of the network. The total number of tiles needed depend on the worst-case block of layers, e.g., block q, for which more tiles will need to be allocated to the q^{th} tier in order to avoid contention back at the 1^{st} tile between portions of the workload wishing to start the q+1^{st} tier and the residual portion of the workload not yet finished with using the q^{th} tier for the last batch-member on that 1^{st} tile.

With this configuration, contention at the input to any given tile is minimized, because each tile frees itself up from executing the last batch-member for a given tier q before data for the first batch-member arrives to start using tier q+1.

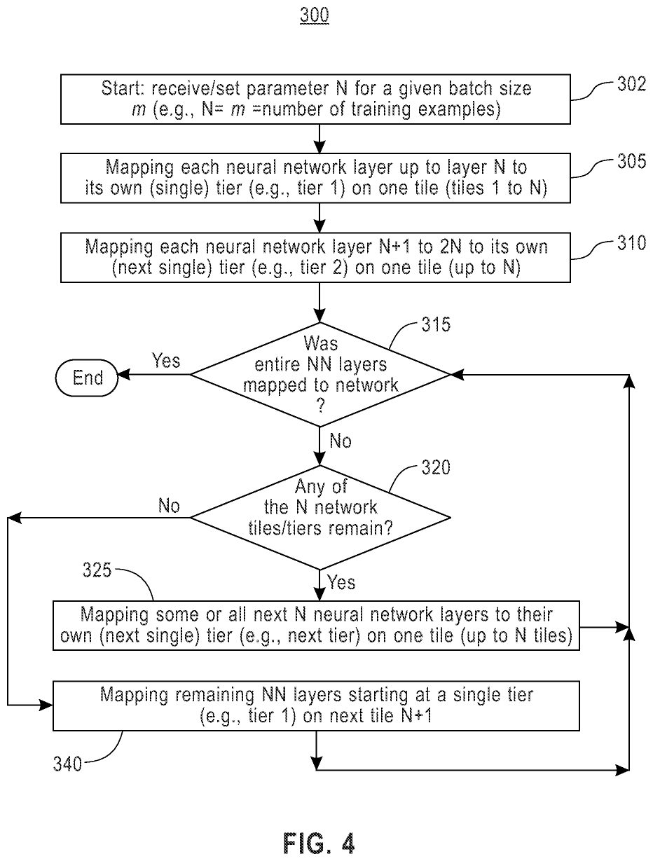

FIG. 4 depicts an exemplary method 300 that can be programmed at a supervisory controller, e.g., a compiled control program of the accelerator system chip or it could be a CPU, either on the same board or elsewhere in the system, or it could be on an embedded core in the same chip, for programming such mapping of NN model layers (of a 3D matrix or tensor) to circuit tiles/tiers as depicted in FIG. 3 for a first case scenario where there is a finite batch-size m of examples (e.g., images for an image classification model).

In a first step 302, there is depicted the chosen parameterization of N (representing the number of layers to be assigned out to unique tiles before returning back to the original 1^{st} tile) to equal m, i.e., the small batch-size number of model training examples, e.g., 8 or 16 or more, NN model training data examples. Then, at 305, there is performed an assigning or mapping of each of the N network layers to its own (single) tier on one tile. In FIG. 3 this is shown as initial mappings 101A, 101B, . . . , 101N, to respective first tiers 45A, 45B, . . . , 45N on respective tiles 110A, 110B, . . . , 110N.

Then, at 310, there is performed the further mapping of layers N+1 to 2N for example, to tier 2 (46A, 46B, etc.) of tiles 1 to N, etc.

Then, at 315, a determination is made as to whether the entire neural network (all layers) have been successively mapped to tiles/tiers. If all NN model layers have been mapped, then the process ends. Otherwise, if is determined that not all of the NN model layers of the m-batch size have been mapped to the successive network tiers/tiles, then the process proceeds to 320 to determine whether any of the N tiles and their respective tiers of the network remain to receive data for layer processing (i.e., all tiers of tiles 1 through N have not been consumed). If there are network tiles/tiers in the network that remain for this batch size, then the process proceeds to 325 where the next N neural network layers are successively mapped to their own next single tier on one tile (up to N tiles). Afterward, the process proceeds back to 315 and 320 where the same system determinations are made for determining whether any more layers that have not yet been mapped can be mapped. The process at 315-325 repeats until there is no more layer mapping (of batch size m) is to be performed, i.e., the entire neural network has been mapped to tiles/tiers, and the process ends.

Otherwise, returning to 320, if it is determined that there are no more of the N tiles or their tiers remain in the physical network, i.e., all available tiers on tiles 1 to N have been consumed yet there are more NN model layers (of batch size m) to be mapped, then the process proceeds to 340 where the process continues by further mapping remaining network layers to tier 1 of tile N+1, et seq. according to the same scheme, and the process proceeds to step 315 the same determination as to whether the entire NN model layers have been mapped to the network. As an alternative, if it is determined that there are no more N tiles or tiers, then it can be decided to increase the parameter size “N”, i.e., choose N*>N such that analogous mapping to tiles 1 to N* is performed such that the entire neural network can be mapped.

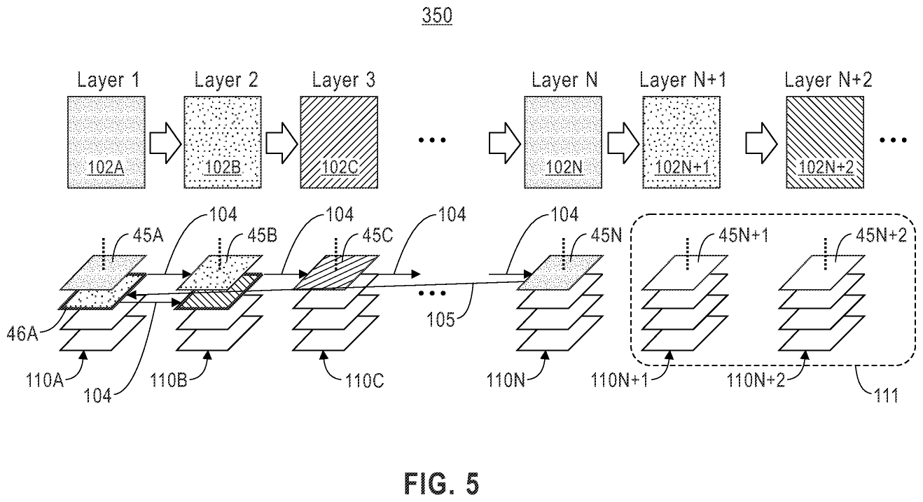

FIG. 5 depicts a model layers lockstep or pipelined processing scenario 350 according to the method of FIG. 4 where batch members proceed from a tier of one tile to the same tier of the next tile next in lockstep for a finite sized batch such as depicted by successive arrows 104 from one tile to its next adjacent tile in an embodiment. That is, FIG. 5 shows the processing of an example network layers mapping scenario according to the embodiment of FIG. 3 where layer 1 network data 102A is mapped to top tier 45A of tile 110A, layer 2 network data 102B is mapped to top tier 45B of tile 110B, layer 3 network data 102C is mapped to top tier 45C of tile 110C, et seq., up to layer N where network data 102N is mapped to top tier 45N of tile 110N. It is noted that in this embodiment, further circuit tiles 111 including two tiles 110N+1 and 110N+2 and their respective tiers, e.g., their first tiers 45N+1, 45N+2 respectively, remain unused and can be utilized for other networks/tasks.

In this embodiment, processing of all batch members proceed from one tile to the next in lockstep such as depicted by successive arrows 104 from one tile to its next adjacent tile. In an embodiment, a control processor (not shown) provided at each tile 110A, 110B, et seq., is programmed with its own code to control the lockstep operation at that respective tile. That is, as determined at compile time, each tile receives code programmed with logic for tracking the status of the batch processing at that tile and for controlling the exact timing of the batch inputs for processing at that layer and the conveyance of the output results at that layer. For example, a 3-D matrix (e.g., a 3-D image matrix tensor) is split up into successive 2-D image matrices according to batch size (e.g., m=8) and each of the eight 2-D image matrices is input for lockstep processing at each of the sequence of layers 110A. 110B, et seq. in pipelined fashion. Initially, the first 2D image matrix of the batch (group of 8) is input for first mapped DNN layer weight-matrix processing (physically executed) at first tier 45A of tile 110A. When that first layer completes processing of the first 2D image matrix input, the matrix multiplication output results at layer 110A including any activation functions resulting as part of the digital computations performed is conveyed at 104 for input to the first tier 45B of second mapped DNN layer weight matrix processing (next layer) at tile 110B. After this conveyance 104, tile 110A becomes free for processing, so the second 2D image matrix of the batch is input for first mapped DNN layer weight-matrix processing at the first tier 45A of tile 110A, and this process repeats for each image matrix of the input batch. While the second 2D image matrix of the example group of 8 batch is input for first DNN layer weight-matrix processing at first tier 45A of tile 110A, the matrix multiplication output results at layer 110A including any activation functions for the first image matrix of the batch are then processed (physically executed) at the first tier 45B of second mapped DNN layer weight matrix processing (next layer) at tile 110B. This lockstep processing continues until all batch members (e.g., all eight 2-D example image matrices) are pipelined processed in like manner. In this embodiment, the m^{th} (i.e., last) batch member completes processing in tier 45A of tile 110A just in time for the first batch member, i.e., Layer N+1 network data 102N+1 to commence processing without delay in the second tier, i.e., tier 46A of tile 110A as shown by lockstep processing arrow 105. This minimizes the mapped footprint (number of tiles used) without negatively affecting (increasing) latency.

In a more general embodiment, it is not the case that each neural network layer is mapped to its own (single) tier on one tile. For example, an alternative can implement choosing a minimum number of tiles (Nₜᵢₗₑ) such that, when layers 1 to N_{layer}s of the neural network are mapped to (e.g.) tier 1 of tiles 1 to Nₜᵢₗₑ, and layer N_{layer}s+1 of the neural network is mapped to (e.g.,) tier 2 of tile 1, the m^{th} (i.e., last) batch member completes processing in tier 1 of tile 1 no later than the first batch member commences processing in tier 2 of tile 1. Then, mapping can occur in an analogous fashion to the method of FIG. 4.

While such mapping scenarios as depicted in the method of FIGS. 3-5 can work for given finite batch-size m or smaller, there will be considerable contention for batch-size larger than m.

For this situation, i.e., for batch-size larger than m, an alternative embodiment is proposed which avoids contention by collapsing all usage of a given tile for a given member of the workload (e.g., one batch-member of a large or even infinite-size batch) into one continuous time-period.

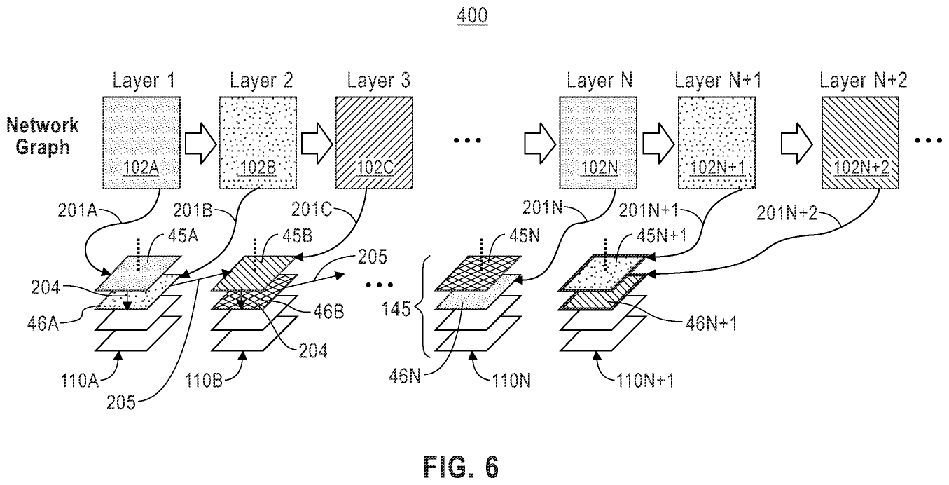

FIG. 6 graphically depicts the alternative embodiment of a mapping arrangement 400 of neural network (NN) model layers 102A, 102B, . . . , 102N, 102N+1 and 102N+2 as in FIG. 2 that need to be computed in lockstep or pipeline, i.e., in successive order, as part of an AI machine learning algorithm. Also depicted is the forming of a 3-D CiM memory system 400 organized as a plurality of circuit tiles 110A, 110B, 110C, . . . , 110N-1, 110N. Each tile 110A, 110B, etc. includes a plurality of tiers 145, each tier configured with CiM processing capability.

In this alternative embodiment, as shown in FIG. 6, computing NN model layers in successive order is accomplished by assigning a same number “D” of tiers-per-tile for receiving successive NN model layers to the same circuit tile. In an embodiment shown in FIG. 6, D=2.

That is, for optimizing total throughput and latency for a “infinite” batch-size of examples, a programmed processor provides a respective mapping of successive “D” layers to the same tile. Thus, as shown in FIG. 6, for an exemplary configuration of D=2 tiers-per-tile, then weight matrix data of neural network model layer 102A is assigned by a mapping 201A to a first circuit tile 110A at first tier 45A and data of NN model layer 102B is mapped at 201B to second tier 46A of first tile 110A for lockstep processing. Further data of NN model layer 102C is mapped at 201C for processing at top tier 45B of next circuit tile 110B and data of a next NN model layer (not shown) is mapped to second tier 46B of next tile 110B for lockstep processing. This mapping of two NN model layers per tile continues where, as shown in the D=2 example of FIG. 6, data of NN Model layer 102N is mapped at 201N for processing at second tier 46N of circuit tile 110N, data of NN Model layer 102N+1 is mapped at 201N+1 for processing at the top tier 45N+1 of circuit tile 110N+1, and data of NN Model layer 102N+2 is mapped at 201N+2 for processing at the second tier 46N+1 of circuit tile 110N+1 for lockstep processing thereat.

In this embodiment, in lockstep or pipelined processing, each tile is busy processing the m′ batch-member until computation is completed on all D layers assigned to that particular tile. That is, all usage of a given tile for a given member of the workload (e.g., one batch-member of a large or even infinite-size batch) is collapsed into one continuous time-period. As before this could include computation for all S tokens within a sequence, across the D layers.

A lockstep processing scenario in accordance with the alternative embodiment shown in FIG. 6, where batch members proceed from a tier of one tile to the next tier of the same tile in lockstep is depicted by successive arrows 204. Once batch-member computation is completed on all D layers assigned to one particular tile, then the batch-member processing proceeds from the last tier of the tile (e.g., tier 46A of tile 110A for D=2) to the top tier of the next tile (e.g., tier 45B of tile 110B) as depicted by arrow 205. This lockstep processing continues for each subsequent tile 110B, et seq., until the final batch-member is processed according to this alternative scheme. This minimizes the mapped footprint (number of tiles used) while minimizing any undesirable impact on latency.

At that point, for the case of the 1^{st} tile, e.g., circuit tile 110A, that circuit tile becomes available to start processing of the next batch-member in the incoming work-flow (e.g., the m+1^{st} batch-member). By keeping this latency-before-accepting-next-input low, the system is now freed from any need to design for a particular batch-size. Assuming that the necessary changes in control strategy and auxiliary digital compute (e.g., activation functions and neural network layers not involving vector-matrix multiplications mapped to in-memory tiles) can be handled, it is even conceivable that this next piece-of-work for the 1^{st} tile can represent a different sequence-length on the same model, or even a completely different model, supported by accessing a different tier on that 1^{st} tile. The assignment strategy depicted in FIG. 6 enables this by ensuring that once a given tile completes its work on the m′, that particular batch-member will never need to return to this particular tile. Assignment of tiers to subsequent tiles completes in a similar manner.

In additional embodiments, any integer number “D” of tiers-per-tile (e.g., D=2, D=3, etc.) and layers can be assigned to a given tile before moving to the next.

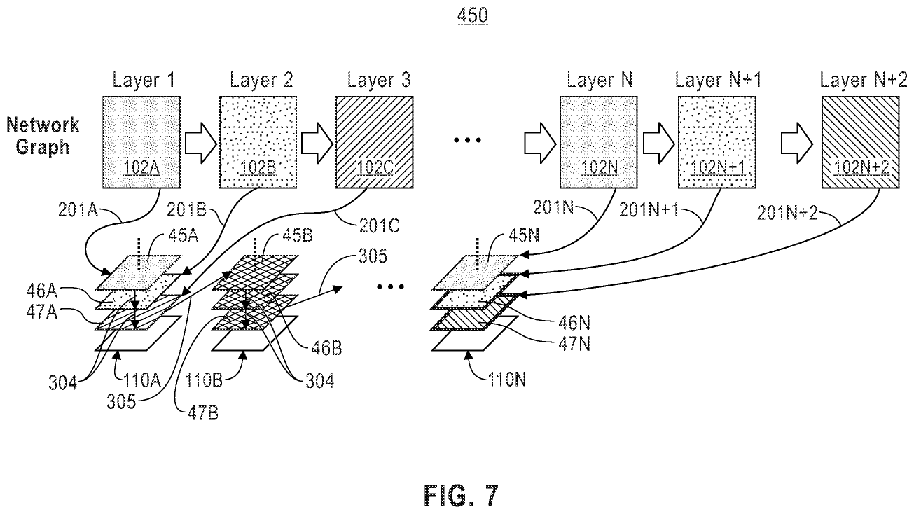

For example, FIG. 7 depicts graphically a second mapping arrangement 450 of neural network (NN) model layers that need to be computed in successive order as part of an AI machine learning algorithm and the employing of a weight assignment strategy for optimizing total throughput and latency for an “infinite” batch-size of inputs according to a second embodiment where D=3. In the exemplary configuration of D=3 tiers-per-tile depicted in FIG. 7, matrix data of neural network model layer 102A is assigned by a mapping 201A to a first circuit tile 110A at tier 45A, matrix data of NN model second layer 102B is mapped at 201B to second tier 46A of first circuit tile 110A and data of NN model third layer 102C is mapped at 201C to a third tier 47A of first circuit tile 110A for lockstep processing. Data of further NN model layers (not shown) is mapped to further tiers 45B, 46B and 47B of next circuit tile 110B. This mapping of three NN model layers per tile continues where, as shown in the D=3 example of FIG. 7, data of NN Model layer 102N is mapped at 201N for processing at top tier 45N of circuit tile 110N, data of NN Model layer 102N+1 is mapped at 201N+1 for processing at the second tier 46N of circuit tile 110N, and data of NN Model layer 102N+2 is mapped at 201N+2 for processing at the third tier 46N+1 of circuit tile 110N for lockstep processing thereat.

A lockstep processing scenario in accordance with the alternative embodiment shown in FIG. 7, where batch members proceed from a tier of one tile to the next tier of the same tile in lockstep is depicted by successive arrows 304. Once batch-member computation is completed on all D layers assigned to one particular tile, then the batch-member processing proceeds from the last tier of the tile (e.g., tier 47A of tile 110A for D=3) to the top tier of the next tile (e.g., tier 45B of tile 110B) as depicted by arrow 305. This lockstep processing continues for each subsequent tile 110B, et seq., until the final batch-member is processed according to this alternative scheme. This minimizes the mapped footprint (number of tiles used) while minimizing any undesirable impact on latency.

In the case that subsequent layers take longer to execute on each tile or tier than on the 1^{st} tile, care is taken to avoid a stall within the execution of the overall workflow. In such a scenario, it can be necessary to use larger D on tiles where the layers can execute rapidly, and smaller D on tiles where layers execute more slowly, in order that the entire workflow can move through the system in a fully pipelined manner without stalls, while still supporting the smallest possible dead-time-before-next-batch-member-can-be-input.

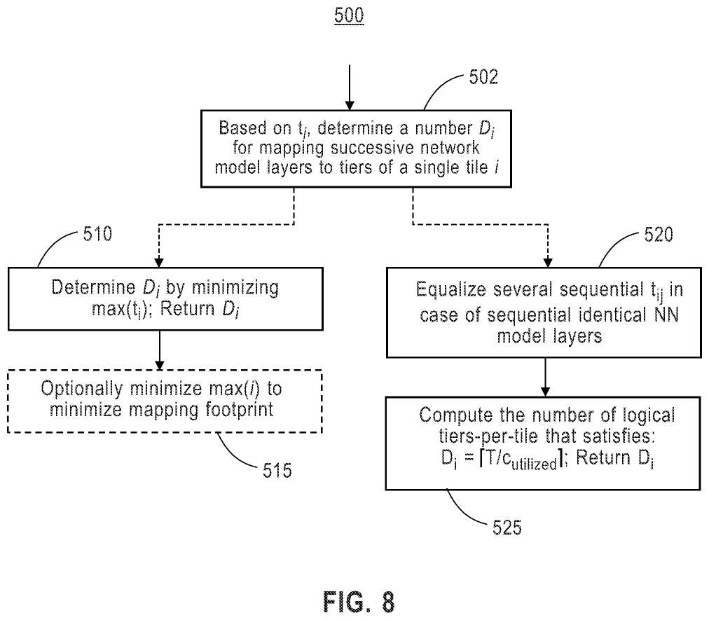

FIG. 8 depicts a method 500 that can be programmed at a supervisory controller for determining D used for the programming of a mapping of NN model layers to circuit tiles/tiers when there is an infinite batch size m of inputs to be processed.

In a first step 502, there is depicted a first step of computing a number “Dᵢ” of tiers-per-tile i based on the value of tᵢ. One option path is shown at step 510 where a set of tiers-per-tile Dᵢ is chosen such as to minimize max(tᵢ), where tᵢ denotes the tile latency of an in-memory tile i, which is computed as a summation of tier processing times according to:

tᵢ>=Σtᵢⱼ

where tᵢⱼ denotes the latency of utilized tier j within that tile i, and where max(tᵢ) denotes the highest such tᵢ found among all in-memory tiles i storing a 2D weight-matrix representing at least a portion of the N neural network model layers. This set of values Dᵢ is returned. A further optional step 515 includes minimizing max(i) to minimize the mapping footprint. Referring back to 502, a second option path is shown at 520 where a set of tiers-per-tile Dᵢ is chosen such as to (at least approximately) equalize several successive tᵢ, i.e., the assignment of layers to tiles/tiers is done such as to result in approximately equal tᵢ for a series of successive tiles. This minimizes tile idle time within this set of tiles. This is particularly desirable in the case of successive identical NN model layers, e.g., in the Bidirectional Encoder Representations from Transformers (BERT) transformer-based machine learning technique for natural language processing. In some embodiments the number of (logical) tiers-per-tile “Dᵢ” then satisfies:

Dᵢ<=[(T/C_{utilized})]

where C_{utilized}=number of utilized tiles and T=number of (logical) tiers required to map all NN CiM layers, and where [x] denotes the smallest integer that is greater than or equal to the real number x.

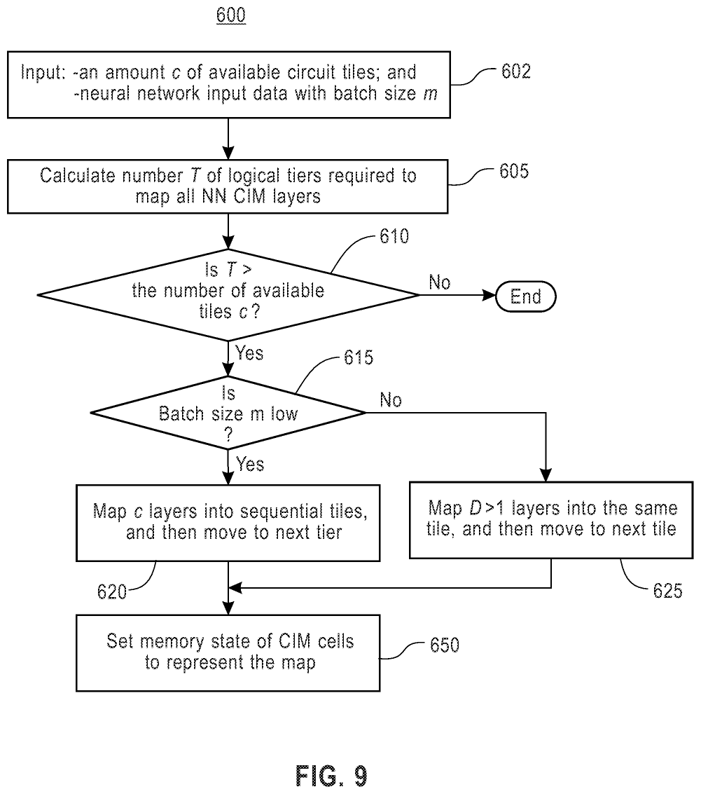

FIG. 9 depicts an overall process flow 600 for configuring a 3D CiM system according to embodiments described herein. At a first step 602 a control processor receives data representing the amount of c available circuit tiles of a 3D CiM system and receives input data of the neural network of layers defining a batch size m. Then, at 605, there is computed the number T of logical tiers required to map all NN CiM layers. Then, at 610, a determination is made to determine whether the number T of logical tiers exceeds the number of tiles c. If it is determined at 610 that T does not exceed the number of tiles c, then there are enough processing tiles for a mapping into logical tiers and the process ends. Otherwise, at 610, if it is determined that C_{required} does exceed the number of available tiles C_{available}, then a determination is made at 615 as to whether the batch size m is low. If it is determined at 615 that the batch size m is low, then the process proceeds to step 620 to map layers into a first (logical) tier (tier 1) of successive tiles until tier 1 of substantially all available tiles has been utilized, and then the process initiates the mapping of further layers to the next tier, and subsequently to higher tiers if that is required. Otherwise, if it is determined at 615 that the batch size m is high, then the process proceeds to step 625 to map into Dᵢ>=1 tiers of tile 1, then move to the next tile, and so forth, mapping into Dᵢ>=1 tiers for each utilized tile i, until all layers of the neural network have been mapped. Finally, after performing the mapping at either steps 620 (finite batch size m) or 625 (infinite batch size m), the process proceeds to step 650 in order for the supervisory controller to set the memory state of the CiM cells to represent the mapping.

In an embodiment, a mapping of a sequence of at least Nₜᵢₑᵣ₁ neural network model layers to tiers of successive in-memory tiles is optimized for a finite input batch-size m of an incoming workflow. To optimize the mapping, one method includes: assigning of layers Nₛₜₐᵣₜ to Nₛₜₐᵣₜ+Nₜᵢₑᵣ₁−1 of the neural network model to a first tier (tier 1) of successive in-memory tiles, e.g., in-memory tiles 1 to Nₜᵢₗₑₛ, each first tier of the successive in-memory tiles 1 to Nₜᵢₗₑₛ configured for storing data representing a 2D weight-matrix for processing at the corresponding neural network model layer; and a further assigning of layer Nₛₜₐᵣₜ+Nₜᵢₑᵣ₁ of the neural network model to a second tier (tier 2) of in-memory tile 1, the second tier of in-memory tile 1 configured for storing data representing a 2D weight-matrix for processing at the corresponding neural network model layer. In this embodiment, Nₜᵢₗₑₛ is a minimum number of tiles chosen such that the first batch member completes processing in tier 1 of tile Nₜᵢₗₑₛ no sooner than the m^{th} batch member completes processing in tier 1 of in-memory tile 1.

Subsequent mapping steps for mapping of a sequence of at least Nₜᵢₑᵣ₁ neural network model layers to tiers of successive in-memory tiles includes an assigning of any successive layers from neural network model layer Nₛₜₐᵣₜ+Nₜᵢₑᵣ₁+1 up to Nₛₜₐᵣₜ+2Nₜᵢₑᵣ₁−1 to tier 2 of in-memory tiles 2 to Nₜᵢₗₑₛ, and further, an assigning of any subsequent successive neural network model layers Nₛₜₐᵣₜ+(x-1)Nₜᵢₑᵣ₁ up to Nₛₜₐᵣₜ+XNₜᵢₑᵣ₁−1 to a next tier (tier x) of tiles 1 to Nₜᵢₗₑₛ for each x in a sequence of at least one successive whole numbers x≥ 3.

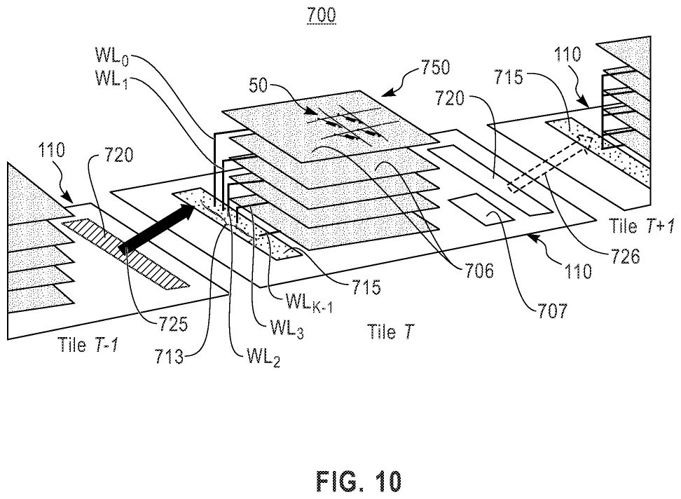

FIG. 10 depicts operations and the lockstep signal/data flow involving example 3D compute-in-memory (CiM) hardware at a tier(s) of a circuit tile 110 of a memory system accelerator in accordance with an embodiment of the invention. FIG. 10 particularly illustrates a portion 700 of a compute-in-memory (CiM) accelerator system, such as shown in FIG. 1, including a series of CiM circuit tiles 110, each tile 110 having a plurality of in-memory tiles employing memory tiers and control circuitry for efficient processing of neural network models according to embodiments herein.

In FIG. 10, CiM accelerator system 100 includes plural tiles 110, each tile storing a matrix data corresponding to a weight associated with a hidden layer of a deep neural network (DNN) having N or more layers. For non-limiting purposes of illustration, FIG. 10 shows a sequence of tiles labeled T-1, T, T+1. In an embodiment, each tile 110 is a circuit, e.g., CMOS logic and compute circuitry (not shown) including components including compute-in-memory (CiM) structures forming a 3-dimensional compute-in-memory system 750 used for accelerating deep learning inference and training. Each 3-dimensional compute-in-memory system 750 includes a plurality of memory cell tiers 706, each tier 706 having an addressable 2-dimensional CiM array including a cross-bar array configuration 50 of memory storage cells 51 for handling neural network processes (e.g., matrix multiplication computations) at a particular neural network layer. Only a single tier of a tile 110 is functional to perform computations at a time. In an embodiment, a memory cell array can store a weight associated with a particular neural network model. In an embodiment, all of the weights reside across multiple tiles in the 3D memory architecture. Because all of the weights reside in the 3D CiM architecture, and the methods perform computations in-memory, the bottleneck of shuttling data back and forth between the memory and a computational unit is completely eliminated. The compute-in-memory accelerator system 700 of FIG. 10 thus enable fast and very energy-efficient model layer processing.

As shown in FIG. 10, in a processing method, once the tiers of the tiles have been assigned and store weight matrix data according to embodiments herein, an initial first step can include the arrival of model input data 725 at a tile T, the model input data including a 2-D matrix of training data associated with a batch (a 3-D tensor). In an embodiment, initial input data 725 can include weight data of a matrix associated with processing at a particular DNN model layer and can arrive under control of a supervisory processor (not shown) at the memory system accelerator chip. This data can be stored at the memristive storage cells crossbar array 50 of a selected tier. In an embodiment, control circuitry 715 can be used to select the tier for receiving the input data 725 according to a particular mapping scheme. During lockstep or pipeline processing, data can 725 can include data received from another (e.g., a prior) tile/processing block and can comprise data “x” including a vector of floating point/integer elements. However, input data 725 can also be a single number (e.g., a vector with a single element). In an embodiment, input data 725 can include intermediate activations (activation functions) received from a prior layer, i.e., from a same or different tier of the same or different tile. For example, as shown in FIG. 10, data 725 can be generated at a scaling and accumulate (gating) circuitry 720 at a prior tile T-1 (a prior DNN model layer) and is received for processing at tile T (e.g., the next DNN hidden model layer). In an embodiment, control circuitry 715 at tile 110 can include tier activation circuitry used to generate a wordline signal (WL) used to select a particular CiM tier 706 at which the received input data, e.g., model layer weight data or batch training data, is to be processed. That is, in CiM accelerator system 700, associated with the CiM structure 750 at a tile 110 is a control circuit 715 including an associated tier activation circuit that includes word line drivers (WLD) 713, e.g., shown as word line drivers WL₀, WL₁, . . . , WL_{K-1}, that connect to corresponding memory tiers 706 for activating a corresponding memory tier(s) to process received inputs. As a tier can be associated with a different model layer, different tiers 706 can hold the weights of different layers/models.

As further shown in system 700, associated with the CiM structure 750 at a processing tile 110 is peripheral circuitry 707 and gating circuitry 720 that can function to scale and accumulate DNN model layer outputs. Peripheral circuitry 707 can include analog/digital converters, digital/analog converters, registers, memory, buffers, filters, etc. for carrying out neural network processing operations at the tile.

At a respective tile 110, control circuit 715 controls the processing in coordination with other adjacent tiles, and when vector-matrix multiplication processing at a respective tile is complete at a tile 110, gating circuitry 720 can provide a scaled and accumulated DNN model layer output 726 for conveyance to the next tile, e.g., tile T+1 where further processing steps are executed in a similar manner at the next layer in the DNN model where the tier activation circuitry of control circuit 715 activates the tier of interest for the next model layer processing.

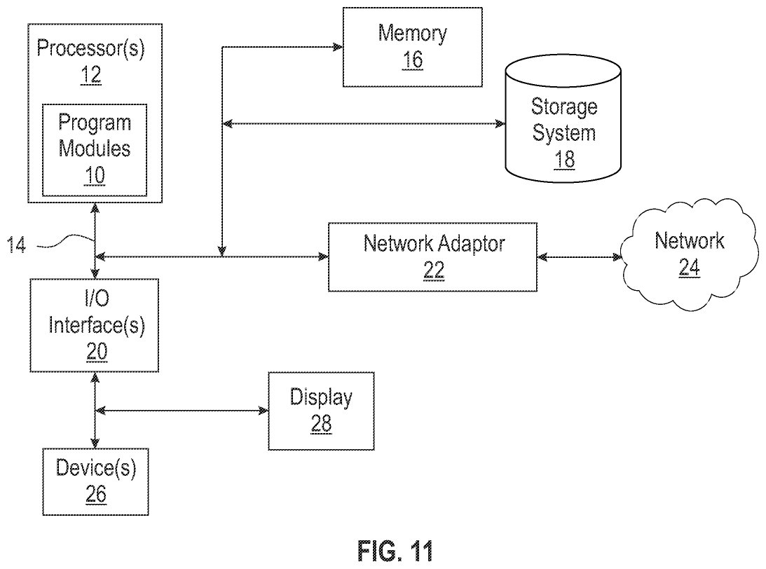

FIG. 11 illustrates an example computing system in accordance with the present invention that may provide the activation of memory tiers depicted in the methods described in FIGS. 4, 8 and 9 for controlling the in a 3D CiM accelerator system. It is to be understood that the computer system depicted is only one example of a suitable processing system and is not intended to suggest any limitation as to the scope of use or functionality of embodiments of the present invention. For example, the system shown may be operational with numerous other general-purpose or special-purpose computing system environments or configurations. Examples of well-known computing systems, environments, and/or configurations that may be suitable for use with the system shown in the figures may include, but are not limited to, integrated circuits, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In some embodiments, the computer system may be described in the general context of computer system executable instructions, embodied as program modules stored in memory 16, being executed by the computer system. Generally, program modules 10 may include routines, programs, objects, components, logic, data structures, and so on that perform particular tasks and/or implement particular input data and/or data types in accordance with the methods described herein with respect to FIGS. 4, 8 and 9.

The components of the computer system may include, but are not limited to, one or more processors or processing units 12, a memory 16, and a bus 14 that operably couples various system components, including memory 16 to processor 12. In some embodiments, the processor 12 may execute one or more modules 10 that are loaded from memory 16, where the program module(s) embody software (program instructions) that cause the processor to perform one or more method embodiments of the present invention. In some embodiments, module 10 may be programmed into the integrated circuits of the processor 12, loaded from memory 16, storage device 18, network 24 and/or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

Memory 16 (sometimes referred to as system memory) can include computer readable media in the form of volatile memory, such as random access memory (RAM), cache memory an/or other forms. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20. Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. Although not shown, other hardware and/or software components could be used in conjunction with the computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays, or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A compute-in-memory (CiM) accelerator system comprising:
a plurality of in-memory tiles, each in-memory tile comprising more than one tier arranged in the Z dimension, each tier of an in-memory tile including an array of memory devices for storing a 2D weight-matrix representing at least a portion of a neural network model layer,
wherein at least one in-memory tile is configured to perform vector-matrix multiplications (VMM) from successive neural network layers mapped into more than one tier, and no in-memory tile is configured to represent vector-matrix multiplications of non-successive neural network layers.

2. The CiM accelerator system as claimed in claim 1, wherein at least two in-memory tiles store a 2D weight-matrix representing at least a portion of the same neural network model layer.

3. The CiM accelerator system as claimed in claim 1, wherein 2D weight matrices representing at least a portion of at least two successive neural network layers are mapped into the same tier of the same in-memory tile.

4. The CiM accelerator system as claimed in claim 1, wherein N neural network model layers are assigned to tiers of in-memory tiles, said assignment of N neural network model layers to tiers of in-memory tiles being optimized for a sample batch-size.

5. The CiM accelerator system as claimed in claim 4, wherein of said N neural network model layers, an amount Dᵢ of successive neural network model layers are assigned to a given in-memory tile i at tiers of that tile i, a usage of successive Dᵢ neural network model layers at the given in-memory tile i being collapsed into one continuous time-period.

6. The CiM accelerator system as claimed in claim 5, wherein each in-memory tile processes a batch-member until vector matrix multiplication computations are completed on all Dᵢ layers assigned to that in-memory tile i.

7. The CiM accelerator system as claimed in claim 5, wherein the amount Dᵢ of assigned successive neural network model layers is determined by minimizing max(tᵢ), where tᵢ comprises a latency of an in-memory tile i, said latency t; computed according to: tᵢ>=Σtᵢⱼ, where tᵢⱼ denotes the latency of utilized tier j within that tile, and where max(tᵢ) denotes the highest such tᵢ found among all in-memory tiles i storing a 2D weight-matrix representing at least a portion of said N neural network model layers.

8. A compute-in-memory accelerator system comprising:
a plurality of in-memory tiles, each in-memory tile comprising more than one tier arranged in the Z dimension, each tier including an array of memory devices adapted for storing a 2D weight-matrix representing at least a portion of a neural network model layer, wherein a mapping of a sequence of at least Nₜᵢₑᵣ₁ neural network model layers to tiers of successive in-memory tiles is optimized for a finite input batch-size m of an incoming workflow, said mapping comprising at least
an assignment of layers Nₛₜₐᵣₜ to Nₛₜₐᵣₜ+Nₜᵢₑᵣ₁−1 of the neural network model to a first tier (tier 1) of successive in-memory tiles 1 to Nₜᵢₗₑₛ, each first tier of the successive in-memory tiles 1 to Nₜᵢₗₑₛ configured for storing data representing a 2D weight-matrix for processing at the corresponding neural network model layer; and
an assignment of layer Nₛₜₐᵣₜ+Nₜᵢₑᵣ₁ of the neural network model to a second tier (tier 2) of in-memory tile 1, the second tier of in-memory tile 1 configured for storing data representing a 2D weight-matrix for processing at the corresponding neural network model layer,
wherein said Nₜᵢₗₑₛ is a minimum number of tiles chosen such that the first batch member completes processing in tier 1 of tile Nₜᵢₗₑₛ no sooner than the m^{th} batch member completes processing in tier 1 of in-memory tile 1; and
a controller unit associated with each in-memory tile configured for controlling a 2D weight-matrix multiplication operation of at least a portion of a neural network model layer at a tier of said in-memory tile.

9. The CiM accelerator system as claimed in claim 8, wherein the number of neural network model layers Nₜᵢₑᵣ₁ to be assigned out to Nₜᵢₗₑₛ unique tiles before returning to an original first in-memory tile is equal to said batch-size m.

10. The CiM accelerator system as claimed in claim 8, wherein said mapping further comprises:
an assignment of any successive layers from neural network model layer Nₛₜₐᵣₜ+Nₜᵢₑᵣ₁+1 up to Nₛₜₐᵣₜ+2Nₜᵢₑᵣ₁−1 to tier 2 of in-memory tiles 2 to Nₜᵢₗₑₛ.

11. The CiM accelerator system as claimed in claim 10, wherein said mapping further comprises:
an assignment of any subsequent successive neural network model layers Nₛₜₐᵣₜ+(x-1)Nₜᵢₑᵣ₁ up to Nₛₜₐᵣₜ+XNₜᵢₑᵣ₁−1 to a next tier (tier x) of tiles 1 to Nₜᵢₗₑₛ for each x in a sequence of at least one successive whole numbers x≥3.

12. A method for operating a compute-in-memory accelerator system comprising:
configuring a plurality of in-memory tiles to store data for processing a neural network model, each in-memory tile comprising more than one tier arranged in the Z dimension, each tier comprising an array of memory devices adapted to store a 2D weight-matrix of data representing a neural network model layer;
mapping of a sequence of greater than N neural network model layers to tiers of successive in-memory tiles optimized for a finite sample batch-size m of an incoming workflow, said mapping comprising at least an assignment of layers Nₛₜₐᵣₜ to Nₛₜₐᵣₜ+Nₜᵢₑᵣ₁−1 of the neural network model to a first tier (tier 1) of successive in-memory tiles 1 to Nₜᵢₗₑₛ, each first tier of the successive in-memory tiles 1 to Nₜᵢₗₑₛ configured for storing data representing a 2D weight-matrix for processing at the corresponding neural network model layer; and an assignment of layer Nₛₜₐᵣₜ+Nₜᵢₑᵣ₁ of the neural network model to a second tier (tier 2) of in-memory tile 1, the second tier of in-memory tile 1 configured for storing data representing a 2D weight-matrix for processing at the corresponding neural network model layer;
wherein said Nₜᵢₗₑₛ is a minimum number of tiles chosen such that the first batch member completes processing in tier 1 of tile Nₜᵢₗₑₛ no sooner than the m^{th} batch member completes processing in tier 1 of in-memory tile 1; and
controlling a processing of a 2D weight-matrix multiplication operation of at least a portion of a said N neural network model layer at a tier of an in-memory tile.

13. The method claimed in claim 12, wherein said mapping further comprises:
an assignment of any successive layers from neural network model layer Nₛₜₐᵣₜ+Nₜᵢₑᵣ₁+1 up to Nₛₜₐᵣₜ+2Nₜᵢₑᵣ₁−1 mapped to tier 2 of in-memory tiles 2 to Nₜᵢₗₑₛ, and

14. The method claimed in claim 13, wherein said mapping further comprises:
an assignment of any subsequent successive neural network model layers Nₛₜₐᵣₜ+(x-1)Nₜᵢₑᵣ₁ to Nₛₜₐᵣₜ+(x)Nₜᵢₑᵣ₁−1 to a next tier (tier x) of tiles 1 to Nₜᵢₗₑₛ for each x in a sequence of at least one successive whole numbers x≥ 3.

15. A compute-in-memory accelerator system comprising:
a plurality of in-memory tiles, each in-memory tile comprising more than one tier arranged in the Z dimension, each tier including an array of memory devices for storing a 2D weight-matrix of data representing a neural network model layer;
a mapping of a sequence of greater than N neural network model layers to tiers of successive in-memory tiles optimized for a large sample batch-size m of an incoming workflow, said mapping comprising at least an assignment of a pre-determined amount of successive neural network model layers to respective successive tiers of a single in-memory tile, each successive tier of the single in-memory tile configured for storing data representing a 2D weight-matrix for processing at the corresponding neural network model layer; and
a hardware controller device configured for controlling a 2D weight-matrix multiplication operation at each said successive neural network model layer at each said successive tier of said given in-memory tile.

16. The CiM accelerator system as claimed in claim 15, wherein at least two in-memory tiles store a 2D weight-matrix representing at least a portion of the same neural network model layer.

17. The CiM accelerator system as claimed in claim 15, wherein 2D weight matrices representing at least a portion of at least two successive neural network layers are mapped into the same tier of the same in-memory tile.

18. The CiM accelerator system as claimed in claim 15, wherein of said N model layers, an amount Dᵢ of successive neural network model layers are assigned to a given in-memory tile i at successive tiers of that tile i, a processing of successive Dᵢ neural network model layers at the given in-memory tile i being collapsed into one continuous time-period.

19. The CiM accelerator system as claimed in claim 18, further comprising a mapping of next successive amounts of Dᵢ successive neural network model layers to each of respective next successive in-memory tiles i, each in-memory tile processing the m^{th} batch-member until matrix multiplication operations are completed on all Dᵢ layers assigned to that in-memory tile i.

20. The CiM accelerator system as claimed in claim 18, wherein the amount Dᵢ of assigned successive neural network model layers is determined by minimizing max(tᵢ) where tᵢ comprises a latency of an in-memory tile i, said latency t; computed according to: tᵢ>=Σtᵢⱼ, where tᵢⱼ denotes the latency of utilized tier j within that tile, and where max(tᵢ) denotes the highest such tᵢ found among all in-memory tiles i storing a 2D weight-matrix representing at least a portion of said N neural network model layers.

21. The CiM accelerator system as claimed in claim 18, wherein a first tile becomes available to start processing of a next batch-member in the incoming workflow when processing of all Dᵢ layers assigned to that first in-memory tile i is completed.

22. A method for operating a compute-in-memory accelerator system comprising:
configuring a plurality of in-memory tiles to store data for processing a neural network model, each in-memory tile comprising more than one tier arranged in the Z dimension, each tier comprising an array of memory devices adapted to store a 2D weight-matrix of data representing a neural network model layer;
mapping of a sequence of greater than N neural network model layers to tiers of successive in-memory tiles optimized for a large sample batch-size m of an incoming workflow, said mapping comprising assigning a pre-determined amount of successive neural network model layers to respective successive tiers of a single in-memory tile, each successive tier of the single in-memory tile configured for storing data representing a 2D weight-matrix for processing at the corresponding neural network model layer; and
controlling a 2D weight-matrix multiplication operation at each said successive neural network model layers at each said successive tier of said given in-memory tile.

23. The method as claimed in claim 22, wherein said mapping further comprises:
of said N model layers, assigning an amount Dᵢ of successive neural network model layers to a given in-memory tile i at successive tiers of that tile i such that a processing of successive Dᵢ neural network model layers at the given in-memory tile i is collapsed into one continuous time-period, and an
assigning of next successive amounts of Dᵢ successive neural network model layers to each of respective next successive in-memory tiles i, each in-memory tile processing the m^{th} batch-member until matrix multiplication operations are completed on all Dᵢ layers assigned to that in-memory tile i.

24. The method as claimed in claim 23, wherein an amount Dᵢ of assigned successive neural network model layers is determined by minimizing max(tᵢ) where tᵢ comprises a latency of an in-memory tile i, said latency tᵢ computed according to: tᵢ>=Σtᵢⱼ, where tᵢⱼ denotes the latency of utilized tier j within that tile, and where max(tᵢ) denotes the highest such tᵢ found among all in-memory tiles i storing a 2D weight-matrix representing at least a portion of said N neural network model layers.

25. The method as claimed in claim 23, wherein a first tile becomes available to start processing of a next batch-member in the incoming workflow when processing of all Dᵢ layers assigned to that first in-memory tile i is completed.
